(19) United States
(12) Patent Application Publication
(10) Pub. No.: US 2012/0320614 A1
(43) Pub. Date: Dec. 20, 2012

(54) WHEEL LIGHTS

(76) Inventor: Robert Malone, Garland, TX (US)

(21) Appl. No.: 13/164,710

(22) Filed: Jun. 20, 2011

(51) Int. Cl. B60Q 9/00

(52) U.S. Cl. 362/500

(57) ABSTRACT

A wheel light assembly may be mounted on wheel studs of a wheel hub, between the wheel hub and the rim of the wheel. The wheel light assembly may include a mounting plate having wheel stud holes in a pattern matching the pattern of the wheel studs onto which the light assembly is to be mounted. The wheel light assembly may further include one or more light bars extending from the mounting plate. The light bars may include one or more lights connected to a power source. The power source may be solar power and/or a battery. The wheel light assembly may include a remote power switch for turning the power to the light bars on and off from inside the vehicle. The vehicle may be an automobile, motorcycle, bicycle or any similar wheeled vehicle.

### BACKGROUND OF THE INVENTION

The present invention relates to wheel lights and, more particularly, to lights mountable onto a wheel hub (rotor) of a vehicle.

Car enthusiasts may replace their standard automobile rims with various styles of decorative rims. For example, various spinning elements may be configured into a decorative rim. Additional, car enthusiasts may also add various lights to their automobiles. For example, running lights maybe be added along an undercarriage of a car to give certain effects.

As can be seen, there is a need for lights that may be added to the wheels of an automobile.

### SUMMARY OF THE INVENTION

In one aspect of the present invention, a wheel light assembly comprises a mounting plate having a plurality of wheel stud holes therein; one or more light bars extending outwardly away from the mounting plate; one or more lights in the light bars; and a power supply to provide power to the lights.

In another aspect of the present invention, a wheel light assembly comprises a mounting plate having a plurality of wheel stud holes therein; an outer ring disposed about the circumference of the mounting plate; one or more light bars extending outwardly away from the outer ring; one or more lights in the light bars; one or more battery packs adapted to provide power to the lights; and one or more solar cells adapted to charge the one or more battery packs.

These and other features, aspects and advantages of the present invention will become better understood with reference to the following drawings, description and claims.

### BRIEF DESCRIPTION OF THE DRAWINGS

FIG. 1 is a front view of a wheel light assembly according to an exemplary embodiment of the present invention;

FIG. 2 is an exploded perspective view of the wheel light assembly of FIG. 1 mounted on a wheel hub; and

FIG. 3 is a front view of a wheel light assembly according to an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a wheel light assembly that may be mounted on wheel studs of a wheel hub, between the wheel hub and the rim of the wheel. The wheel light assembly may include a mounting plate having wheel stud holes in a pattern matching the pattern of the wheel studs onto which the light assembly is to be mounted. The wheel light assembly may further include one or more light bars extending from the mounting plate. The light bars may include one or more lights connected to a power source. The power source may be solar power and/or a battery. The wheel light assembly may include a remote power switch for turning the power to the light bars on and off from inside the vehicle.

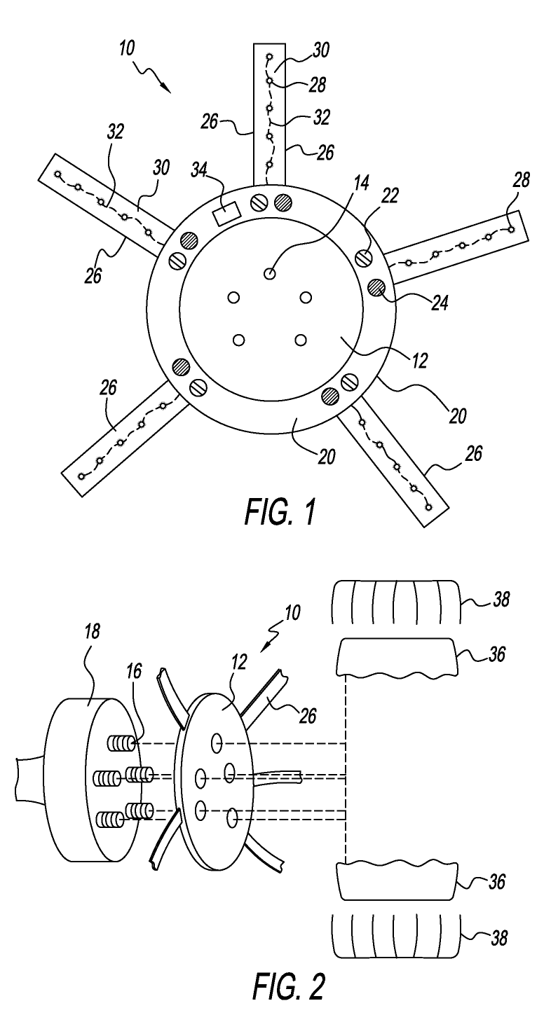

Referring to FIGS. 1 and 2, a wheel light assembly 10 may include a mounting plate 12 that may have wheel stud holes 14 disposed in a pattern therewithin. The pattern of the wheel stud holes 14 may match a pattern of wheel studs 16 on a wheel hub 18 onto which the wheel light assembly 10 is to be mounted. The mounting plate 12 may be made of metal, such as an alloy metal, steel, stainless steel, aluminum and the like.

An outer ring 20 may be disposed about the circumference of the mounting plate 12. The outer ring 20 may be made of, for example, plastic, or may be made of a material similar to the mounting plate 12. The outer ring 20 may contain one or more batteries 22 and one or more solar cells 24. One or more light bars 26 may extend from the outer ring 20. In some embodiments, a battery 22 and a solar cell 24 may be provided for each light bar 26. In other embodiments, a single battery 22 and/or solar cell 24 may power multiple light bars 26. Typically, from about 2 to about 10 light bars 26, often from about 4 to about 6 light bars 26, may extend outwardly from the outer ring 20.

The batteries 22 may be rechargeable batteries, such as lithium-ion rechargeable batteries. The batteries 22 may be recharged with the solar cells 24 when able. Electronics (not shown) may be disposed in the light assembly 10 to provide proper charging of the batteries 22 from the solar cells 24.

The light bars 26 may extend generally orthogonally from the outer ring 20. Each light bar 26 may be from about 2 inches to about 10 inches in length, typically from about 4 inches to about 6 inches in length. Each light bar 26 may contain one or more lights 28, typically light emitting diodes (LEDs). The light bars 26 may be formed of a clear or colored tubing 30. In some embodiments, the tubing 30 may be colored to compliment the color of the vehicle onto which the wheel light assembly 10 is to be mounted. Wires 32 may connect the lights 28 to each other and to a power supply (such as the battery 22). The light bars 26 may be spaced apart equally about the outer ring 20, thereby preventing vibration. The lights 28 may be colored lights and may be controlled to turn on, burning steady, or may be controlled to flash, alternate, or provide a pattern of lights.

A receiver 34 may be disposed in the outer ring 20. The receiver 34 may receive a signal from a transmitter (not shown) operated by a user to turn on or turn off power to the light bars 26. In some embodiments, there may be a single receiver 34 controlling power to the light bars 26. In other embodiments, multiple receivers 34 may be used. In this embodiment, the user may have the ability to selectively turn on or off various light bars 26 for different effects.

The wheel light assembly 10 may be adapted to mount onto the wheel studs 16 of a wheel hub 18. A wheel rim 36, holding a tire 38, may be mounted over the wheel light assembly 10. The wheel rim 36 may be held in place with lug nuts (not shown), as is known in the art. The wheel rim 36 may be a rim of any variety of vehicles, such as automobiles, motorcycles, bicycles, and the like.

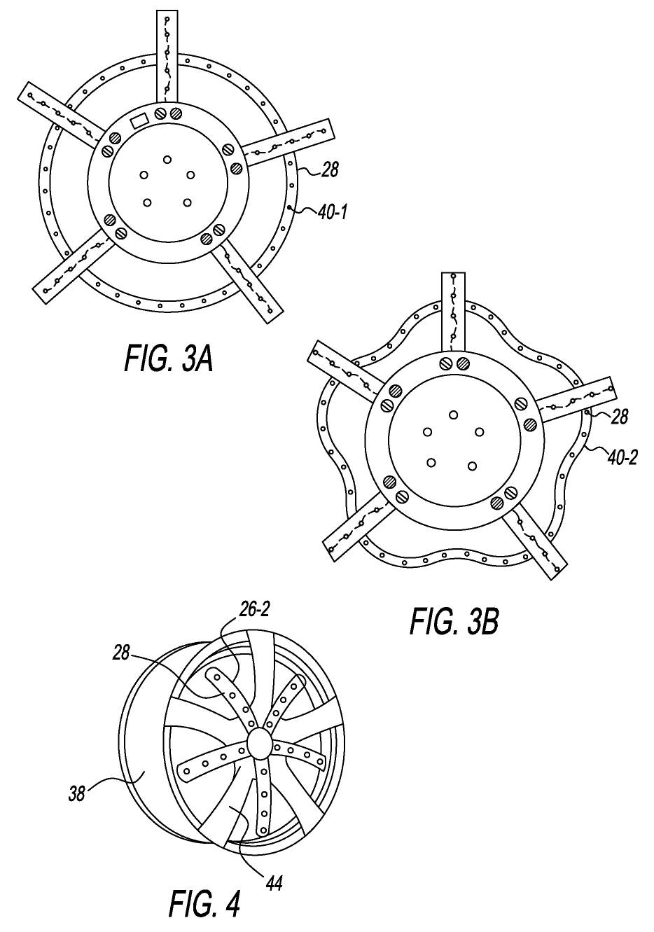

Referring now to FIGS. 3A and 3B, one or more light rings 40-1, 40-2 may be spaced outwardly from the outer ring 20. The light rings 40-1, 40-2 may interconnect adjacent light bars 26. In some embodiments, the light rings 40-1 may be concentric to the outer ring 20 (FIG. 3A). In other embodiments, the light rings 40-2 may be wavy (FIG. 3B). The light rings 40-1, 40-2 may contain one or more lights 28.

While the present invention is described as a separate piece that fits on the wheel lugs prior to the rim and tire, the wheel light assembly may be integrally formed with the rim 36. As shown in FIG. 4, light bars 26-1 may extend from the rim 36, typically between the spokes 44 of the rim 36. The light bars 26-1 may be formed in various configurations. Lights 28 may be disposed in or along the light bars 26-1.

It should be understood, of course, that the foregoing relates to exemplary embodiments of the invention and that modifications may be made without departing from the spirit and scope of the invention as set forth in the following claims.

What is claimed is:

1. A wheel light assembly comprising:
a mounting plate having a plurality of wheel stud holes therein;
one or more light bars extending outwardly away from the mounting plate;
one or more lights in the light bars; and
a power supply to provide power to the lights.

2. The wheel light assembly of claim 1, further comprising an outer ring disposed about the circumference of the mounting plate, the light bars extending outwardly from the outer ring.

3. The wheel light assembly of claim 2, wherein the light bars extend orthogonally from the outer ring.

4. The wheel light assembly of claim 1, further comprising one or more battery packs for providing power to the lights.

5. The wheel light assembly of claim 4, further comprising one or more solar cells providing power to recharge the battery packs.

6. The wheel light assembly of claim 5, wherein one of the battery packs and one of the solar cells are provided for each of the light bars.

7. The wheel light assembly of claim 1, further comprising a receiver for receiving a signal from a user to turn on or turn off power to the lights.

8. The wheel light assembly of claim 1, wherein the mounting plate is made of metal.

9. The wheel light assembly of claim 1, wherein the lights are light emitting diodes.

10. The wheel light assembly of claim 1, wherein the light bars are made of a clear plastic material.

11. The wheel light assembly of claim 2, further comprising one or more light rings spaced outwardly from the mounting plate, the one or more light rings interconnecting adjacent light bars.

12. The wheel light assembly of claim 11, wherein the one or more light rings are disposed generally concentric to the outer ring.

13. A wheel light assembly comprising:
a mounting plate having a plurality of wheel stud holes therein;
an outer ring disposed about the circumference of the mounting plate;
one or more light bars extending outwardly away from the outer ring;
one or more lights in the light bars;
one or more battery packs adapted to provide power to the lights; and
one or more solar cells adapted to charge the one or more battery packs.

14. The wheel light assembly of claim 13, wherein one of the battery packs and one of the solar cells are provided for each of the light bars.

15. The wheel light assembly of claim 13, further comprising a receiver for receiving a signal from a user to turn on or turn off power to the lights.
